(19) United States
(12) Patent Application Publication
(10) Pub. No.: US 2007/0057100 A1
(43) Pub. Date: Mar. 15, 2007

(54) Forged blade for bale processing machines

(76) Inventors: Melvin Svendsen, Calgary (CA); Donald Stoesz, Langdon (CA)

Correspondence Address: ADE & COMPANY INC., 2157 Henderson Highway, WINNIPEG, MB, R2G1P9, CA

(21) Appl. No.: 11/491,498

(22) Filed: Jul. 24, 2006

Related U.S. Application Data
(60) Provisional application No. 60/716,528, filed on Sep. 14, 2005.

(51) Int. Cl. B02C 18/18

(52) U.S. Cl. 241/220

(57) ABSTRACT

A bale processing machine features blades that gradually increase in width toward their cutting edges. The blades are mounted on a rotating drum by pivot pins passing through eye portions of the blades. By gradually increasing the width of the blade portion extending outward from the eye portion, the effective cutting area is increased without the significant increase in mass associated with widening a typical blade of uniform width. Furthermore, this gradual widening concentrates mass at the blade tip to better distribute kinetic energy at the cutting edge of the blade during drum rotation. In a second embodiment, the blade is twisted along the blade portion to set the cutting edge at an angle to improve cutting performance in the case where the drum and the strands of baled material are parallel by ensuring the cutting edge extends across the strands.

This application claims benefit of U.S. provisional application 60/716,528 filed Sep. 14, 2005.

This invention relates to blades for bale processing machines, and more particularly to a forged blade having a large cutting area to improve the efficiency of a bale processing machine.

### BACKGROUND OF THE INVENTION

Bale processing machines are used primarily in the livestock agricultural industry to chop or shred bales of straw or hay for animal feed and bedding material. Typically such a machine includes a rotating drum that has a number of blades mounted on pivot pins circumferentially and longitudinally distributed over the surface of the drum. The blades hang from the pins when the drum is stationary and extend radially outward from the drum when the drum is rotated at a sufficient operating speed. Cutting edges extending across the blades at an end opposite the pins cut baled material that is fed through the machine for processing.

The type of blade used in these machines features an eye portion through which the pivot pin is passed and a blade portion extending from the eye portion to a cutting edge at the end. Conventionally these blades have been of uniform width, meaning that the width of the cutting edge at the end of the blade portion has been the same width as the eye portion. In this uniform design, increasing the size of the cutting edge requires an increase of the blade's width over its entire length, thereby significantly increasing the mass of the blade. The increase in mass and the increase in size of the cutting edge counteract each other, as the added mass decreases the efficiency of driving the rotating drum while the change in the cutting edge increases the effective cutting area of the machine.

As a result, there is a desire for a blade assembly for a bale processing machine offering an increase in effective cutting area while minimizing the corresponding increase in blade mass.

### SUMMARY OF THE INVENTION

According to a first aspect of the invention there is provided a bale processing machine comprising:

a frame;

a drum supported on the frame for rotational motion about a longitudinal axis of said drum;

a plurality of pivot pins supported on an outer surface of the drum, each pivot pin extending along said drum; and

a plurality of blade members each comprising:

an eye portion having a cylindrical opening therein through which a respective one of the pivot pins passes; and

a curved blade portion extending longitudinally from the eye portion in a direction radially outward from the cylindrical opening of said eye portion, said curve blade portion having a cutting edge at an end opposite said eye portion;

each blade member being pivotally supported on the respective pivot pin for motion between a hanging position in which said blade member hangs from said pivot pin and a cutting position in which said blade member extends generally radially outward relative to the drum from said pin;

the curved blade portion of each blade member being wider at the cutting edge than at the eye portion;

the drum being driven for rotation such that the blade members pivot to the cutting position during said rotation.

The blades of the drum assembly are wider at their cutting edges than at their eye portions where they are pivotally mounted on the pins. This results in a larger cutting area per blade with a smaller increase in mass than that associated with widening the blade over its entire width.

Preferably the curved blade portion of each blade member gradually increases in width toward the cutting edge. This prevents the formation of corners associated with a sudden jump in width. Corners act as stress risers that weaken the blade. The smooth increase in width maintains a high level of strength in the blade.

The cutting edge of each blade member may be parallel to a longitudinal axis of the cylindrical opening of the eye portion. Alternatively, the cutting edge of each blade member may be disposed at a relative angle to a longitudinal axis of the cylindrical opening of the eye portion. In this case, preferably the curved blade portion of each blade member comprises a twisted portion extending from the eye portion toward the cutting edge, said twisted portion being twisted about one side thereof such that the blade portion is parallel to and flush with the eye portion at said eye portion and said blade portion is at the relative angle to said flat end of the eye portion between the twisted portion and the cutting edge.

Preferably the pivot pins are arranged in circumferentially spaced rows extending along the drum.

Preferably adjacent pivot pins in each row are equally spaced apart.

The rows may each have an equal number of pivot pins. In this case, the rows of pivot pins may be longitudinally aligned such that each pivot pin in one of the rows has a respective pivot pin in each of the other rows at an equal longitudinal position on the drum.

Alternatively, the rows of pivot pins may be longitudinally offset such that the pins of adjacent rows have different longitudinal positions on the drum. In the case where the cutting edge of each blade member is disposed at a relative angle to a longitudinal axis of the cylindrical opening of the eye portion and the pivot pins are arranged in circumferentially spaced rows extending along the drum, the cutting edges of adjacent blade members in each row may be angled toward opposite ends of the drum. In other words, the relative angles of the cutting edges to the longitudinal axes of the cylindrical openings of the eye portions of the adjacent blade members in each row are taken about opposite sides of said axes in opposite ones of clockwise and counterclockwise directions.

Preferably the blade members comprise forged alloy steel.

According to a second aspect of the invention there is provided a blade member for a bale processing machine, said blade member comprising:

an eye portion having a cylindrical opening therein; and

a curved blade portion extending longitudinally from the eye portion in a direction radially outward from the cylindrical opening of said eye portion, said curve blade portion having a cutting edge at an end opposite said eye portion;

the curved blade portion of each blade member being wider at the cutting edge than at the eye portion.

### BRIEF DESCRIPTION OF THE DRAWINGS

In the accompanying drawings, which illustrate exemplary embodiments of the present invention:

FIG. 1 is an isometric view of a conventional blade for a bale processing machine.

FIG. 2 is an isometric view of a blade for a bale processing machine according to a first embodiment of the present invention.

FIG. 3 is a top plan view of the blade of FIG. 2.

FIG. 4 is a side view of the blade of FIG. 2.

FIG. 5 is an isometric view of a drum assembly for a bale processing machine having blades of the type shown in FIG. 2.

FIG. 6 is an isometric view of a blade for a bale processing machine according to a second embodiment of the present invention.

FIG. 7 is an isometric view of a drum assembly for a bale processing machine having blades of the type shown in FIG. 6 oriented so that their cutting edges facing the same direction.

FIG. 8 is an isometric view of a drum assembly for a bale processing machine having blades of the type shown in FIG. 6 wherein the cutting edges of adjacent blades in each row face opposite directions.

FIG. 9 is an isometric view of a drum assembly for a bale processing machine having blades of the type shown in FIG. 6 arranged in offset rows to form a spiral configuration.

### DETAILED DESCRIPTION

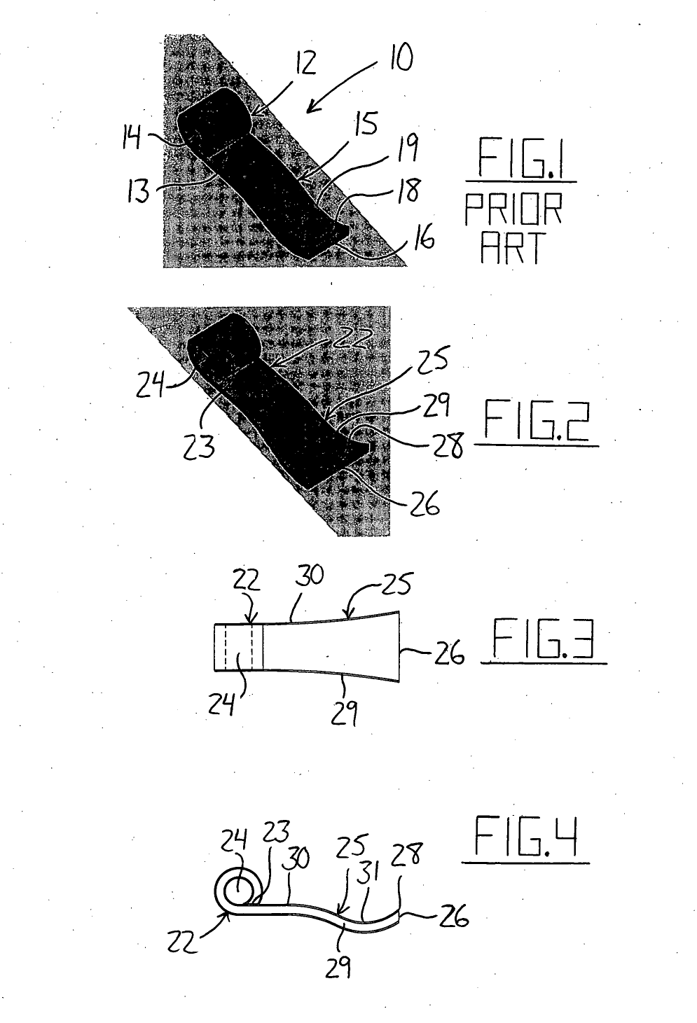

FIG. 1 shows a conventional blade 10 for a bale processing machine. A thin strip of material is shaped to define an eye portion 12 that is formed by rolling of an end 13 back over the strip to create a cylindrical opening 14 used to mount the blade 10 on a pivot pin. A blade portion 15 extends from the eye portion 12 to an opposite end 16 having a cutting edge 18. The sides 19 of the blade portion 15 are concavely curved near the end 16 in order to define the sharp cutting edge 18. The blade portion extends generally parallel to a radius of the cylindrical opening 16 from the eye portion 12 before curving downward. As seen in the figure, the conventional blade 10 is of a uniform width from end to end.

FIG. 2 shows a blade 20 for a bale processing machine according to a first embodiment of the present invention. Again, a thin strip of material is rolled back over itself to form an eye portion 22 at a first end 23 to define a cylindrical opening 24 for receiving a pivot pin. A blade portion 25 extends from the eye portion 22 to an opposite end 26 having a cutting edge 28. The sides 29 of the blade portion 25 are concavely curved near the end 26 in order to define the sharp cutting edge 28. The blade portion extends generally parallel to a radius of the cylindrical opening 26 from the eye portion 22 before curving downward. The blade 20 differs from the conventional blade 10 of FIG. 1 in that the blade 20 is not of uniform width. As can be seen, the sides 29 of the blade portion 25 diverge as they extend away from the eye portion 22, increasing the width of the blade portion 25 at the end 26 opposite the eye portion 22 at the other end 24. This increases the length of the cutting edge 28 so that each blade in a bale processing machine will cut the baled material over a larger area.

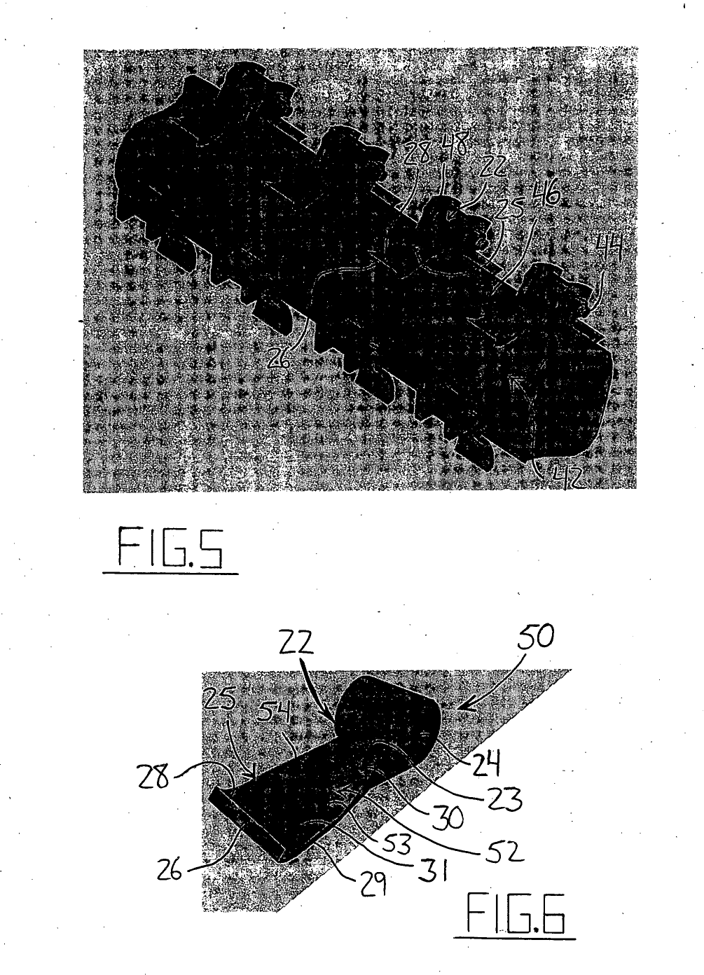

As shown in the overhead and side views of FIGS. 3 and 4, the eye portion 22 of the blade 20 can be considered to extend to a flat end 30 opposite the rolled end 23 defining the opening 24. With this definition, the eye portion 22 is of uniform width just as it is in the conventional blade. The eye portion 22 extends in a flat manner parallel to the radius of the opening 24 from the bottom of the opening 24 to the end 30. The blade portion 25 extends from the flat end 30 of the eye portion 22 to the cutting edge 28 at the opposite end 26. The sides 29 of the blade portion 25 diverge by means of each one curving outward to widen the blade portion 25 as they extend away from the eye portion 22 to the cutting edge 28. As a result, the cutting edge 28 at the end 26 is the widest part of the blade 20. The sides 29 also curve downward and then upward moving from the flat end 30 of the eye portion 22 to the opposite end 26. This defines the concave curvature 31 of the blade portion 25. This curved surface 31 intersects with the end 26 at an angle less than ninety degrees, creating the sharp cutting edge 28.

FIG. 5 shows the blade 20 of the first embodiment as installed in a drum assembly 40 for a bale processing machine. The assembly 40 features a drum 42 that is supported for driven rotation about a longitudinal axis. Pivot pins 44 are supported on an outer surface 46 of the drum 42. The pins 44 extend parallel to the length of the drum 42 and are arranged in rows extending the length of the drum 42. The pins 44 in each row are equally spaced apart and the rows are equally spaced about the circumference of the drum 42. Each pin 44 passes through supports 48 having one of the blades 20 between them. The pin 44 passes through the cylindrical opening 24 of the eye portion 22 so as to support the blade 20 for pivotal motion about the pin 44. When the drum 42 is stationary, the blades 20 extend downward from the pins 44 in a hanging position shown in the figure. It should be appreciated that when the drum 42 is driven at a sufficient rotational speed, the blades 20 will extend radially outward from the surface 46 of the drum with their cutting edges 28 leading in the direction of rotation.

As can be seen in FIG. 5, by widening the end 26 of the blades 20 with the cutting edge 28, the overall cutting area of the drum assembly 40 is increased. This increases the cutting efficiency of the machine. It should be realized that in order to achieve the same cutting area with the conventional blades 10 of uniform width, either more blades would have to be mounted on the drum 42 or the width of each blade would have to be increased. This would significantly increase the mass of the blades 10, increasing the amount of input energy needed to drive rotation of the drum 42. The blade 20 of the present invention increases the cutting area of the machine with a lower increase in mass. In other words, the ratio of cutting area to blade mass is significantly improved over that of the blade of uniform width. In addition, the widening of the blade 20 at the end 26 concentrates more mass near the cutting edge 28 which increases the kinetic energy at the cutting area during operation of the machine.

FIG. 6 shows a blade 50 for a bale processing machine according to a second embodiment of the invention. Like the blade 20 of the first embodiment, the eye portion 22 of the blade 20 is of uniform width and extends to a flat end 30 opposite the rolled end 23 defining the opening 24. The eye portion 22 extends in a flat manner parallel to the radius of the opening 24 from the bottom of the opening 24 to the end 30. The blade portion 25 extends from the flat end 30 of the eye portion 22 to the cutting edge 28 at the opposite end 26. The sides 29 of the blade portion 25 diverge as they extend away from the eye portion 22 such that the cutting edge 28 at the end 26 is the widest part of the blade 20. From the flat end 30 the sides 29 also curve downward and then upward to define the concave surface 31 of the blade portion 25. This curved surface 31 intersects with the end 26 at an angle less than ninety degrees, creating the sharp cutting edge 28. The blade 50 of the second embodiment differs in that the blade portion 25 includes a twisted portion 52.

The twisted portion 52 extends from the flat end 30 of the eye portion 22 to an angled end 53 between the flat end 30 and the opposite end 26 of the blade portion 25 with the cutting edge 28. The twisted portion 52 has been twisted about one of its sides 54 such that the opposite side angles downward from the flat end 30 of the eye portion 22. The twisted portion 52 is flush with and parallel to the eye portion at the flat end 30 and deformed to a maximum angle relative to the flat end 30 at the angled end 53. The rest of the blade portion 25 extends from this angled end 53 to the cutting edge 28. As a result of the twist, the cutting edge 28 at the end 26 opposite the eye portion 22 is oriented at the same angle to the flat end 30 as the angled end 53. As seen in FIGS. 8 to 9, the cutting edge 28 of these blades 50 are not parallel to the longitudinal axis of the drum 42 of a bale processing machine, unlike those of the first embodiment. When the drum 42 extends parallel to the strands of material in the bale being processed, these blades 50 will cut the material more effectively than a blade with a cutting edge parallel to the drum as the cutting edge will extend across the strands rather than along them. Obviously, more effective cutting will break down the bale faster.

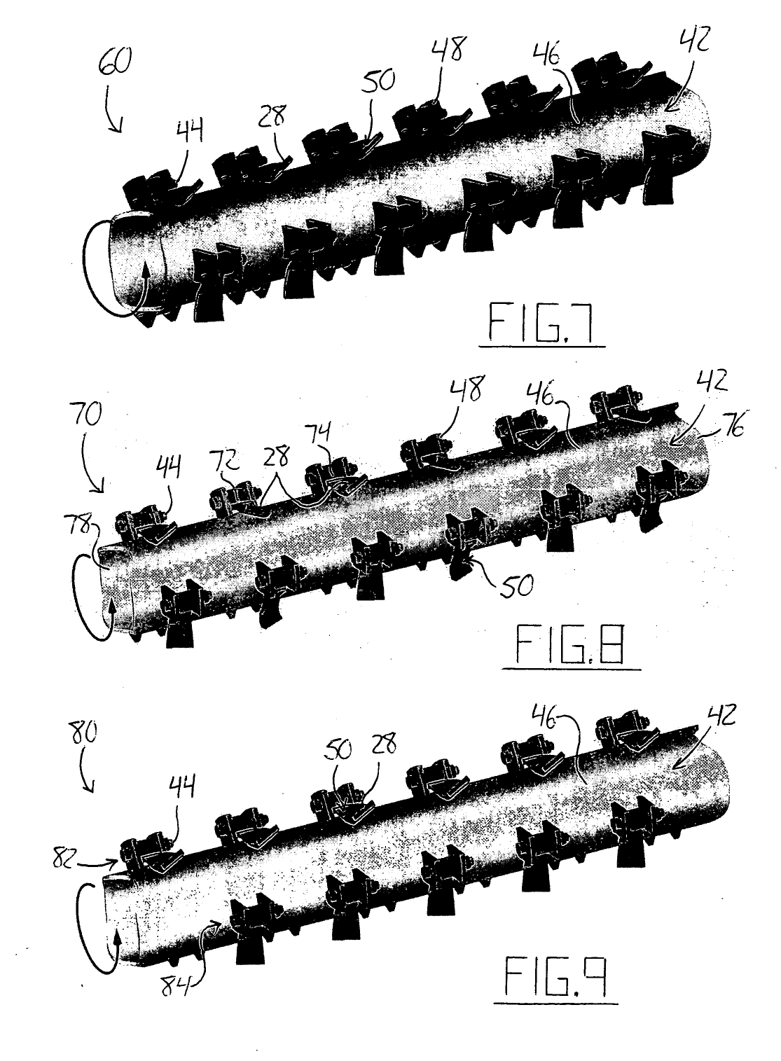

FIG. 7 shows a drum assembly 60 similar to that of FIG. 5, except that the assembly features blades 50 according to the second embodiment. The blades 50 are disposed on pins 44 in circumferentially spaced rows in which the pins 44 are equally spaced. The rows are longitudinally aligned and each have an equal number of pins 44 spaced apart in the same manner. Each pin 44 has a respective pin 44 in each of the other rows that is positioned equally along the drum 42. The blades 50 are all the same such that their cutting edges 28 are oriented to face the same direction. This will help move the material in that same direction as it is broken off the bale.

FIG. 8 shows an alternate drum assembly 70 featuring blades 50 according to the second embodiment. In this alternate assembly 70, the pins 44 are arranged in the same fashion as the previous drum assembly 60. In this case however, the blades 50 are not all the same. Two different versions of blades 50 of the second embodiment are provided, the difference being that the sides 54 about which the twisted portions 52 are twisted downward are opposite between the two versions. This results in the cutting edges 28 of the two versions of blades 50 being angled toward opposite directions transverse to the blades 50. In the drum assembly 70, adjacent blades 72 and 74 in each row are of these two blade types. As a result, the cutting edges 28 of the neighbouring blades 72 and 74 angle to face towards opposite ends 76 and 78 of the drum 42. This arrangement will provide a finer cut of the baled material. In other words, arranging blades of opposite twist direction in an alternating fashion will reduce the overall size of the resulting processed material as the neighbouring blades cut in opposite directions against each other.

A further alternate drum assembly 80 is shown in FIG. 9. Similar to the first assembly 60 featuring blades 50 according to the second embodiment, here the blades 50 all twist in the same direction such that the cutting edges 28 are oriented to face the same direction. The difference is that the pins 44 are arranged in a spiral configuration about the drum surface 46. This is achieved by longitudinally offsetting adjacent rows 82 and 84 having equal pin spacing such that the pins 44 of one row are not disposed in the same position along the drum 42 as the pins 44 of the other rows.

The blade members 20 and 50 described above are each single pieces forged from high strength alloy steel. The cylindrical opening 24 is formed in one end for attachment to a respective pivot pin 44 on the rotating drum 42 of a bale processing machine. The width is maintained in the eye portion 22 to achieve a constant land or beating area to the interfacing components. The opening 24 of the eye portion 22 may have a bushing inserted to withstand the rotating motion of the blade about the pin. The blade portion 25 extending from the eye portion is forged so that it increases in width towards the cutting edge 28. The resulting increased cutting area moves the mass towards the outer periphery of the working area giving maximum energy to the blade tip. In the second embodiment (FIG. 6), the blade portion 25 is twisted to set the cutting edge 28 on an angle to further assist in cutting the material. The blades may be mounted on the drum 42 of the machine such that the angles of the cutting edges 28 are parallel, thereby assisting the movement of the material in one direction (FIGS. 7 and 9). Blades being twisted about opposite sides may also be mounted with the angles of the cutting edges 28 opposing each other so that the material is cut a finer consistency (FIG. 8). Either one of the blade embodiments 20 and 50 can be mounted in aligned or offset rows on the drum 42.

It should be noted that further alternate embodiments of blades having variable width can be developed through modification of those described above. While forging the blades to gradually increase in width toward the cutting edge provides improved grain structure and resulting strength of the blade, it should be appreciated that blades with widened cutting edges can be manufactured in other ways. The gradual increase also eliminates the presence of stress risers associated with corners created by a sudden increase in width, thereby maintaining a high strength in the blade. The twisted portion of the blade with the angled cutting edge may extend the full length of the blade portion and the eye portion does not have to extend as far from the cylindrical opening as shown in the figures. The pins can be arranged on the drum in any number of ways not limited to those described above and illustrated in the figures. The blades may also be made of materials other than high strength alloy steel. The blades may be used on different styles of bale processing machines having implements mounted on a rotating member to break down baled material.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A bale processing machine comprising:
a frame;
a drum supported on the frame for rotational motion about a longitudinal axis of said drum;
a plurality of pivot pins supported on an outer surface of the drum, each pivot pin extending along said drum; and
a plurality of blade members each comprising:
an eye portion having a cylindrical opening therein through which a respective one of the pivot pins passes; and
a curved blade portion extending longitudinally from the eye portion in a direction radially outward from the cylindrical opening of said eye portion, said curve blade portion having a cutting edge at an end opposite said eye portion;
each blade member being pivotally supported on the respective pivot pin for motion between a hanging position in which said blade member hangs from said pivot pin and a cutting position in which said blade member extends generally radially outward relative to the drum from said pin;
the curved blade portion of each blade member being wider at the cutting edge than at the eye portion;
the drum being driven for rotation such that the blade members pivot to the cutting position during said rotation.

2. The bale processing machine according to claim 1 wherein the curved blade portion of each blade member gradually increases in width toward the cutting edge.

3. The bale processing machine according to claim 1 wherein the cutting edge of each blade member is parallel to a longitudinal axis of the cylindrical opening of the eye portion.

4. The bale processing machine according to claim 1 wherein the cutting edge of each blade member is disposed at a relative angle to a longitudinal axis of the cylindrical opening of the eye portion.

5. The bale processing machine according to claim 4 wherein the curved blade portion of each blade member comprises a twisted portion extending from the eye portion toward the cutting edge, said twisted portion being twisted about one side thereof.

6. The bale processing machine according to claim 5 wherein the blade portion of each blade member is parallel to and flush with the eye portion at said eye portion and said blade portion is at the relative angle to the longitudinal axis of the cylindrical opening of the eye portion between the twisted portion and the cutting edge.

7. The bale processing machine according to claim 1 wherein the pivot pins are arranged in circumferentially spaced rows extending along the drum.

8. The bale processing machine according to claim 7 wherein the rows of pivot pins are longitudinally offset such that the pins of adjacent rows have different longitudinal positions on the drum.

9. The bale processing machine according to claim 4 wherein the pivot pins are arranged in circumferentially spaced rows extending along the drum and the cutting edges of adjacent blade members in each row are angled toward opposite ends of the drum.

10. The bale processing machine according to claim 1 wherein the blade portion of each blade member has been formed by forging.

11. The bale processing machine according to claim 1 wherein each blade member comprises alloy steel.

12. A blade member for a bale processing machine, said blade member comprising:
an eye portion having a cylindrical opening therein through which a respective one of the pivot pins passes; and
a curved blade portion extending longitudinally from the eye portion in a direction radially outward from the cylindrical opening of said eye portion, said curve blade portion having a cutting edge at an end opposite said eye portion;
the curved blade portion of each blade member being wider at the cutting edge than at the eye portion.

13. The blade member according to claim 12 wherein the curved blade portion gradually increases in width toward the cutting edge.

14. The blade member according to claim 12 wherein the cutting edge is parallel to a longitudinal axis of the cylindrical opening of the eye portion.

15. The blade member according to claim 12 wherein the cutting edge is disposed at a relative angle to a longitudinal axis of the cylindrical opening of the eye portion.

16. The blade member according to claim 15 wherein the curved blade portion comprises a twisted portion extending from the eye portion toward the cutting edge, said twisted portion being twisted about one side thereof.

17. The blade member according to claim 16 wherein the blade portion is parallel to and flush with the eye portion at said eye portion and said blade portion is at the relative angle to the longitudinal axis of the cylindrical opening of the eye portion between the twisted portion and the cutting edge.

18. The blade member according to claim 12 wherein the blade portion has been formed by forging.

19. The blade member according to claim 12 comprising alloy steel.
